(19) United States
(12) Patent Application Publication
(10) Pub. No.: US 2014/0297963 A1
(43) Pub. Date: Oct. 2, 2014

(54) PROCESSING DEVICE

(71) Applicant: FUJITSU LIMITED, Kawasaki-shi (JP)

(72) Inventors: Takatoshi FUKUDA, Sagamihara (JP); Kenjiro MORI, Fukuoka (JP); Shuji TAKADA, Kawasaki (JP)

(73) Assignee: FUJITSU LIMITED, Kawasaki-shi (JP)

(21) Appl. No.: 14/181,756

(22) Filed: Feb. 17, 2014

(30) Foreign Application Priority Data
Mar. 27, 2013 (JP) 2013-067130

(51) Int. Cl. G06F 12/08

(52) U.S. Cl. CPC G06F 12/0808
USPC 711/135

(57) ABSTRACT

When an invalidation request is inputted from another processing device, a cache controller registers a set of an invalidation request address which the invalidation request has and an identifier of the other processing device which outputted the invalidation request in an invalidation history table. When a central processing unit attempts to read data at a first address not stored in a cache memory, if the first address is registered in the invalidation history table, the cache controller outputs a coherent read request containing the first address to the other processing device indicated by the identifier of the other processing device which outputted the invalidation request corresponding to the first address, or if the first address is not registered in the invalidation history table, the cache controller outputs a coherent read request containing the first address to all other processing devices.

### CROSS-REFERENCE TO RELATED APPLICATION

This application is based upon and claims the benefit of priority of the prior Japanese Patent Application No. 2013-067130, filed on Mar. 27, 2013, the entire contents of which are incorporated herein by reference.

### FIELD

The embodiments discussed herein are directed to a processing apparatus, and particularly directed to coherence technology of cache memory.

### BACKGROUND

A parallel processing system using plural processing units (CPU) as means for improving performance of an information processing system using a computer is known. In the parallel processing system, the sameness of the contents of cache memories which respective CPUs have needs to be maintained. This is called cache coherency, and several methods for maintaining the cache coherency efficiently will be described.

There is known a cache system having a history table storing an address contained in an access request flowing through a common bus and a history table control circuit (see, for example, Patent Document 1). The history table control circuit determines whether the address of a received access request is stored in the table or not. When the address is stored in the table, operation of a cache control circuit which is related to the access request is suppressed, and when the address is not stored in the table, the cache control circuit is made to perform operation related to the access request.

Further, there is known a multicast table storing information indicating whether or not each processor unit is caching data belonging to each of plural regions of a main memory having a size larger than or equal to a cache line (see, for example, Patent Document 2). Destinations of a coherent processing request to be sent to other processor units are limited based on information stored in this table, and this request is partially broadcasted to the limited destinations over a mutual coupling network. When returning a cache state of data specified by the request, a processor unit that is a destination returns together a caching status in the processor unit regarding a specific memory region containing the data in the processor unit. The request source processor unit updates the multicast table based on this return.

Patent Document 1: Japanese Laid-open Patent Publication No. 09-293060

Patent Document 2: Japanese Laid-open Patent Publication No. 09-311820

In a parallel processing system in which plural processing devices (nodes) each constituted of a processing unit (CPU) and a cache memory attached to the CPU are connected with each other, data shared by the nodes need to be the same in their respective cache memories. The sameness of the cache memories is called cache coherency. As an algorithm for maintaining the cache coherency, there is a snoop method. In the snoop method, to maintain the cache coherency, one node outputs various snoop requests to all the other nodes. However, when the node unconditionally outputs requests to all the other nodes, data on the mutual coupling network connecting the nodes become congested, and processing performance of the processing system decreases. This becomes more significant as the number of nodes increases. Further, the other caches receiving the snoop request become delayed in requests from the CPU which are their original purposes due to responding operations, and this has been causing decrease in performance.

### SUMMARY

A processing device has a cache memory which stores a copy of part of data of a main memory, a central processing unit which accesses data in the cache memory, a cache controller which controls the cache memory, and an invalidation history table, wherein when an invalidation request is inputted from another processing device, the cache controller registers a set of an invalidation request address which the invalidation request has and an identifier of the other processing device which outputted the invalidation request in the invalidation history table, and when the central processing unit attempts to read data at a first address not stored in the cache memory, if the first address is registered in the invalidation history table, the cache controller outputs a coherent read request containing the first address to the other processing device indicated by the identifier of the other processing device which outputted the invalidation request corresponding to the first address, or if the first address is not registered in the invalidation history table, the cache controller outputs a coherent read request containing the first address to all other processing devices.

Further, a processing device has a cache memory which stores a copy of part of data of a main memory, a central processing unit which accesses data in the cache memory, a cache controller which controls the cache memory, and a coherent read history table, wherein when a coherent read request is inputted from another processing device, the cache controller registers a set of a coherent read request address which the coherent read request has and an identifier of the other processing device which outputted the coherent read request in the coherent read history table, and when the central processing unit attempts to rewrite data at a second address of the cache memory, if the second address is registered in the coherent read history table, the cache controller outputs an invalidation request containing the second address to the other processing device indicated by the identifier of the other processing device which corresponds to the second address registered in the coherent read history table, or if the second address is not registered in the coherent read history table, the cache controller outputs an invalidation request containing the second address to all other processing devices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a structural example of a processing system according to an embodiment;

FIG. 2 is a diagram illustrating a structural example of a switch control unit of the processing system according to the embodiment;

FIG. 3 is a diagram illustrating a structural example of part of a cache memory and a cache controller of FIG. 1;

FIG. 4 is a diagram illustrating a structural example of an invalidation history table, a comparator, and a logical product (AND) circuit in a history table of FIG. 1;

FIG. 5 is a diagram illustrating a structural example of a coherent read history table, a comparator, and a logical product circuit in the history table of FIG. 1;

FIG. 6 is a flowchart illustrating read processing of a node;

FIG. 7 is a flowchart illustrating write processing of a node;

FIG. 8 is a diagram illustrating how states of cache memories change before and after a snoop request is executed in this embodiment;

FIG. 9 is a diagram illustrating how states of cache memories change before and after a snoop request is executed in this embodiment; and

FIG. 10 is a diagram illustrating another example of the coherent read history table in the history table of FIG. 1.

### DESCRIPTION OF EMBODIMENTS

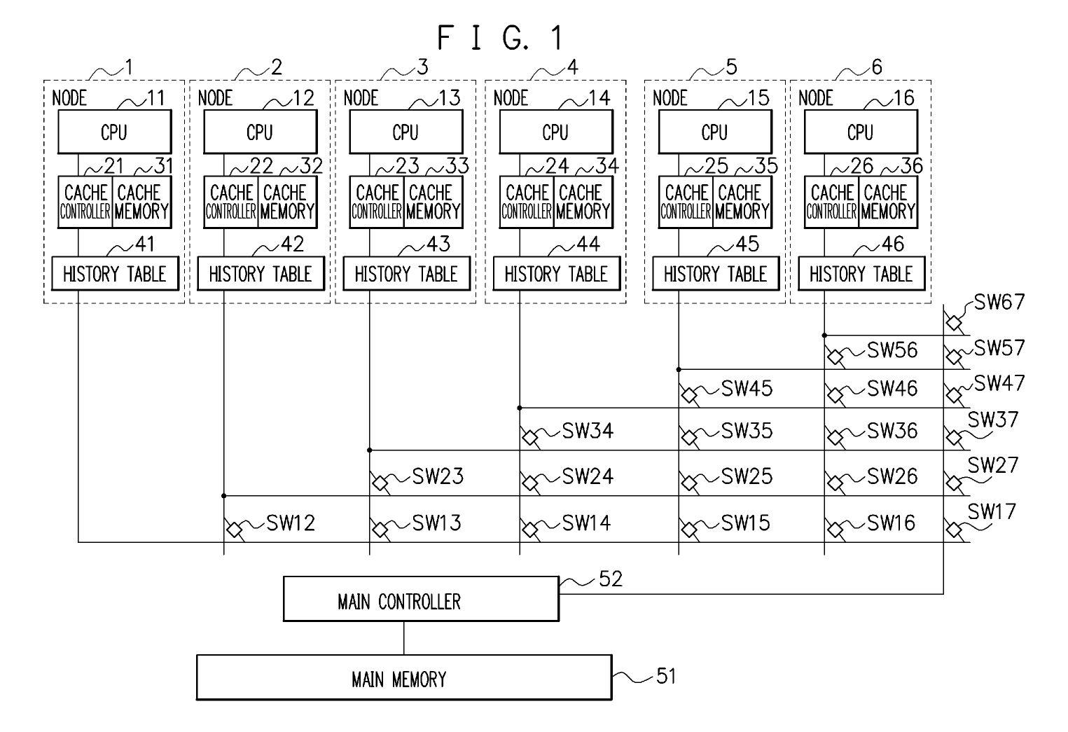

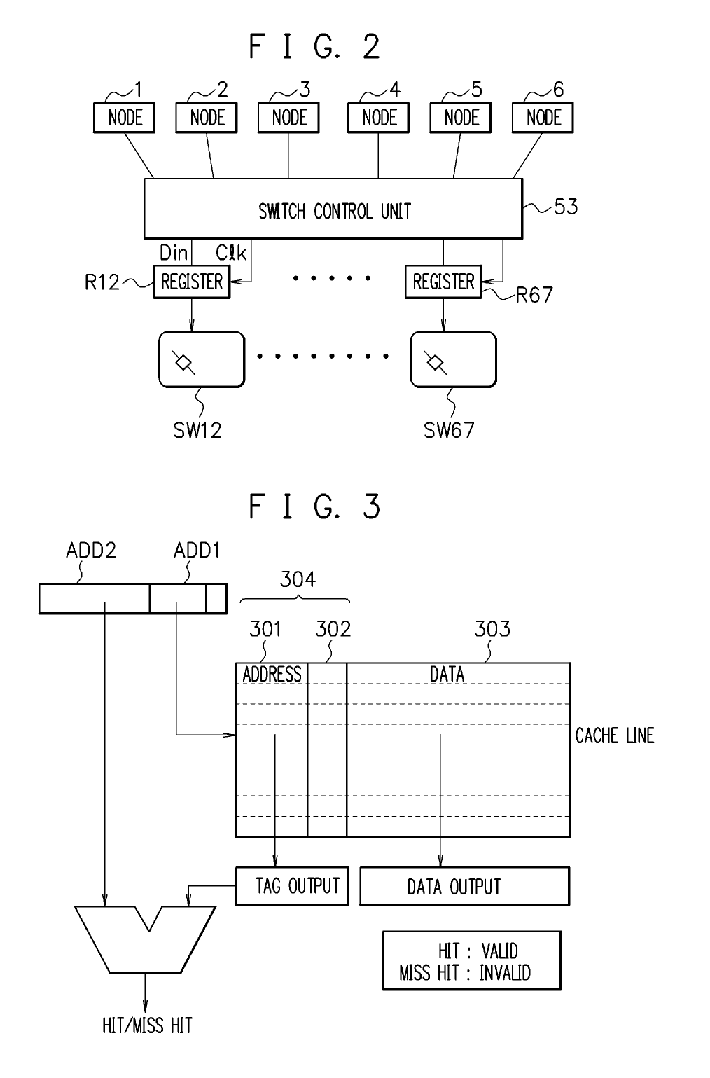

FIG. 1 and FIG. 2 are diagrams illustrating a structural example of a processing system according to an embodiment. The processing system has first to sixth nodes 1 to 6, switches SW12 to SW67, a main memory 51, a main memory controller 52, a switch control unit 53, and registers R12 to R67. The nodes 1 to 6 and switches SW12 to SW67 of FIG. 2 are the same as the nodes 1 to 6 and switches SW12 to SW67 of FIG. 1.

The first node 1 is a first processing device and has a first central processing unit (CPU) 11, a first cache controller 21, a first cache memory 31, and a first history table 41.

The second node 2 is a second processing device and has a second CPU 12, a second cache controller 22, a second cache memory 32, and a second history table 42.

The third node 3 is a third processing device and has a third CPU 13, a third cache controller 23, a third cache memory 33, and a third history table 43.

The fourth node 4 is a fourth processing device and has a fourth CPU 14, a fourth cache controller 24, a fourth cache memory 34, and a fourth history table 44.

The fifth node 5 is a fifth processing device and has a fifth CPU 15, a fifth cache controller 25, a fifth cache memory 35, and a fifth history table 45.

The sixth node 6 is a sixth processing device and has a sixth CPU 16, a sixth cache controller 26, a sixth cache memory 36, and a sixth history table 46.

The main memory 51 stores instructions for the respective CPUs to perform processing and data to be processed by the CPUs or data resulted from processing. The main memory controller 52 controls the main memory 51 in response to a request from each node. The cache memories 31 to 36 each store a copy of data at part of addresses stored in the main memory 51. The CPUs 11 to 16 are central processing units (processors) and each access data in the main memory 51 or the cache memories 31 to 36. The cache controllers 21 to 26 control the cache memories 31 to 36, respectively.

The switches SW12 to SW67 are switches for forming a mutual coupling network which mutually connect the first to sixth nodes 1 to 6. The switch SW12 can connect the first node 1 and the second node 2 with each other. The switch SW13 can connect the first node 1 and the third node 3 with each other. The switch SW14 can connect the first node 1 and the fourth node 4 with each other. The switch SW15 can connect the first node 1 and the fifth node 5 with each other. The switch SW16 can connect the first node 1 and the sixth node 6 with each other. The switch SW17 can connect the first node 1 and the main memory controller 52 with each other.

The switch SW23 can connect the second node 2 and the third node 3 with each other. The switch SW24 can connect the second node 2 and the fourth node 4 with each other. The switch SW25 can connect the second node 2 and the fifth node 5 with each other. The switch SW26 can connect the second node 2 and the sixth node 6 with each other. The switch SW27 can connect the second node 2 and the main memory controller 52 with each other.

The switch SW34 can connect the third node 3 and the fourth node 4 with each other. The switch SW35 can connect the third node 3 and the fifth node 5 with each other. The switch SW36 can connect the third node 3 and the sixth node 6 with each other. The switch SW37 can connect the third node 3 and the main memory controller 52 with each other.

The switch SW45 can connect the fourth node 4 and the fifth node 5 with each other. The switch SW46 can connect the fourth node 4 and the sixth node 6 with each other. The switch SW47 can connect the fourth node 4 and the main memory controller 52 with each other.

The switch SW56 can connect the fifth node 5 and the sixth node 6 with each other. The switch SW57 can connect the fifth node 5 and the main memory controller 52 with each other.

The switch SW67 can connect the sixth node 6 and the main memory controller 52 with each other.

The switch control unit 53 writes data Din in synchronization with a clock signal CK to the registers R12 to R67 in response to a request from the first to sixth nodes 1 to 6. The switches SW12 to SW67 turn on or off according to the data written to the registers R12 to R67, respectively.

FIG. 2 is a block diagram of switch control. The switch control unit 53 receives switch control signals sent from the nodes 1 to 6, and writes on/off of control information of the respective switches to the registers R12 to R67 paired respectively with the switches SW12 to SW67. For example, each switch turns on when “1” is written, and turns off when “0” is written.

FIG. 3 is a diagram illustrating a structural example of the cache memories 31 to 36 of FIG. 1. The cache memories 31 to 36 are a memory of high-speed and small capacity compared to the main memory 51, and normally a copy of part of the main memory is stored in a cache memory. Provided with the cache memories 31 to 36, the CPUs 11 to 16 are able to access data at high speed. FIG. 3 illustrates a cache memory of direct-map method and MESI protocol. Each cache memory 31 to 36 stores one or more sets of a tag 304 and data 303. The tag 304 has an address 301 and a status 302. In one line of data 303, normally, data of a few words of the main memory 51 can be stored. The amount of one line of tag 304 and data 303 is referred to as one entry. An address input of the cache memory is connected to a lower address ADD1 of the CPU, and when the lower address ADD1 of the CPU is determined, data of one entry of the cache memory are read out. The status 302 indicates any one of an invalid state I, a shared state S, an exclusive state E, and a modified state M.

The invalid state I indicates that data 303 at the address 301 corresponding to this status is invalid. When the first cache memory 31 and the second cache memory 32 store the same data 303 at the same address 301, it is necessary to maintain cache coherency if the data 303 at the address 301 of the first cache memory 31 are changed. In this case, in order to indicate that the data 303 at the address 301 of the second cache memory 32 are old data, the status 302 corresponding to the data 303 at the address 301 of the second cache memory 32 is set to the invalid state I.

The shared state S indicates a state that plural cache memories share the same data 303 at the same address 301. For example, when plural cache memories store the same data 303 at the same address 301 among the cache memories 31 to 36, the statuses 302 of the plural cache memories storing the same data 303 at the same address 301 all become the shared state S.

The exclusive state S indicates a state that only one cache memory stores the data 303 at the address 301. For example, when only one cache memory stores the data 303 at the address 301 in the cache memories 31 to 36, the status 302 of the cache memory becomes the exclusive state E.

The modified state M indicates a state that a central processing unit has changed the data 303 at the address 301 in the cache memory. For example, when the CPU 11 has rewritten the data 303 at the address 301 in the cache memory 31, the status 302 corresponding to the data 303 at the address 301 in the cache memory 31 becomes the modified state M. In this state, the data 303 in the cache memory 31 and data in the main memory 51 are different data.

First, an invalidation request will be described. As described above, for example, when the first cache memory 31 and the second cache memory 32 store the same data 303 at the same address 301, the statuses 302 corresponding to the data 303 at the address 301 of the first cache memory 31 and the second cache memory 32 are both in the shared state S. In this state, when the first CPU 11 attempts to rewrite the data 303 at the address 301 in the first cache memory 31, the CPU outputs an invalidation request containing the address information to all the other nodes 2 to 6 in order to maintain the cache coherency. In the second node 2, when the cache memory 32 is read by using the address information of the inputted invalidation request, the same address exists in the address 301 and the same data exist in the same data 303, and the shared state S is outputted as the status, which is a cache hit. In this case, according to the invalidation request from the first node 1, the status 302 corresponding to the data 303 at the address 301 in the second cache memory 32 is set to the invalid state I. Further, the nodes 3 to 6 read the cache memory 32 by using the address information of the inputted invalidation request. However, the data 303 at the address 301 of the invalidation request do not exist in the cache memories 33 to 36 and hence invalidation processing is not performed, but access to the respective cache memories occur and access from the CPU is put on standby in this period. Further, as described above, the first node 1 outputs the same invalidation request to all the other nodes 2 to 6 via the switches SW12 to SW16 in an ON state. In this case, all the switch paths are occupied, and thus communication among other nodes or with the main memory is disturbed, which decreases the advantage of the buses of switch fabric type by half and lowers the performance of the processing system.

In this embodiment, by providing the history tables 41 to 46 of FIG. 1, the first node 1 does not output the invalidation request to all the other nodes 2 to 6, but turns on only the switch SW12 and outputs the invalidation request only to another node 2 which is needed, thereby freeing the switches SW34 to SW67. Thus, communication among the other nodes or with the main memory can be secured, and since no access is performed to the cache memories 33 to 36, access from the CPUs to the respective cache memories is not disturbed, thereby improving the performance of the processing system.

Next, a coherent read request will be described. For example, let us consider the case where the first CPU 11 makes a read request for data at a certain address, but the data at the address do not exist in the first cache memory 31, which is a miss hit. In this case, data at this address in the main memory 51 are not necessarily latest data. That is, there may be cases where the second node 2 reads out data at a certain address in the main memory 51 and writes the data to the second cache memory 32, and thereafter the CPU 12 rewrites the data in the cache memory 32. In this case, the status 302 corresponding to the data at the address in the second cache memory 32 becomes the modified state M. In this case, the data in the second cache memory 32 are latest, and do not match the data in the main memory 51. Accordingly, the first node 1 generally outputs the coherent read request for the address to all the other nodes 2 to 6 in order to maintain the cache coherency. In this case, since the status 302 corresponding to the data at the address of the inputted coherent read request is the modified state M, the second node 2 writes back the latest data at this address in the second cache memory 32 to the main memory 51, and the first node 1 reads the latest data at the address in the main memory 51 and writes them to the cache memory 31. Further, in the nodes 3 to 6, the data at the address of the inputted coherent read request do not exist in the cache memories 33 to 36, but access to the cache memories occur due to the coherent read request, and access from the CPU is put on standby in this period. As described above, the first node 1 outputs the same coherent read request to all the other nodes 2 to 6 via the switches SW12 to SW16 in the ON state. In this case, all the switch paths are occupied, and thus communication among the other CPUs or with the main memory is disturbed, which decreases the advantage of the buses of switch fabric type by half and lowers the performance of the processing system.

In this embodiment, by providing the history tables 41 to 46 of FIG. 1, the first node 1 does not output the coherent read request to all the other nodes 2 to 6, but turns on only the switch SW12 and outputs the request only to another node 2 which is needed, thereby freeing the switches SW34 to SW67. Thus, communication among the other nodes or with the main memory can be secured, and since no access is performed to the cache memories 33 to 36, access from the respective CPUs to the cache memories is not disturbed, thereby improving the performance of the processing system.

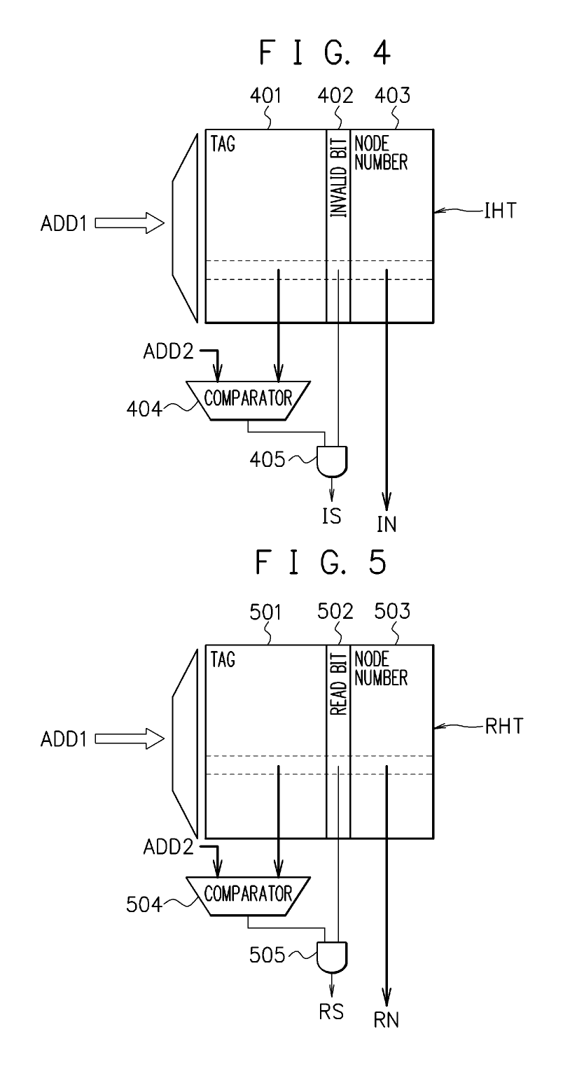

An example of this embodiment will be described in detail below. The history tables 41 to 46 of FIG. 1 are each constituted of an invalidation history unit of FIG. 4 and a coherent read history unit of FIG. 5. The invalidation history unit of FIG. 4 is constituted of an invalidation history table IHT, a comparator 404, and a logical product (AND) circuit 405. A tag section 401 stores an upper address ADD2 similarly to the address 301 of the cache memory of FIG. 3, in which an invalid bit 402 of “0” indicates that this line of the invalidation history table IHT is invalid, and an invalid bit 402 of “1” indicates that it is valid. A node number 403 indicates which node the invalidation request is received from and stores the node number thereof. The coherent read history unit of FIG. 5 is constituted of a coherent read history table RHT, a comparator 504, and a logical product (AND) circuit 505. A tag section 501 stores an upper address ADD2 similarly to the address 301 of the cache memory of FIG. 3, in which a read bit 502 of “0” indicates that this line of the coherent read history table RHT is invalid, and a read bit 502 of “1” indicates that it is valid. A node number 503 indicates which node the coherent read request is received from and stores the node number thereof. At a time of initialization the history tables are invalid, that is, the invalid bit 402 and the read bit 502 are “0”. The comparator 504 compares a tag 501 outputted by the coherent read history table RHT and the upper address ADD2, and outputs “1” when the both match and outputs “0” when the both do not match. The logical product circuit 505 outputs as a read state RS a logical product value of an output value of the comparator 504 and the read bit 502 outputted by the coherent read history table RHT.

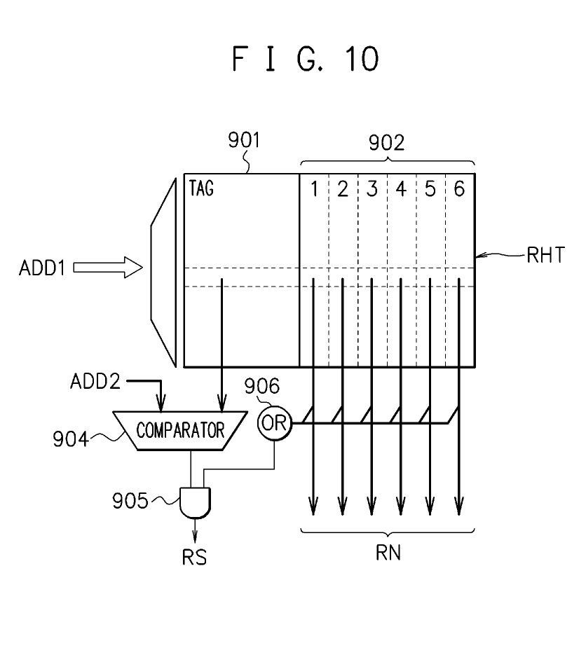

FIG. 10 is a diagram illustrating another embodiment of the coherent read history unit. The coherent read history unit is constituted of a tag section 901, a node map section 902, a coherent read history table, a comparator 904 and a logical product (AND) circuit 905, and a logical sum (OR) circuit 906. The tag section 901 stores an upper address ADD2 similarly to the address 301 of the cache memory of FIG. 3, and in the node map section 902, “0” indicates that the coherent read request did not come from the node corresponding to this bit position, and “1” indicates that the coherent read request came from the node corresponding to this bit position. The logical sum circuit 906 outputs a logical sum of respective valid node bits RN of the node map section 902, and when any one node bit is “1”, the output thereof becomes “1”. An output of the tag section 901 and the upper address ADD2 are compared by the comparator 904, and the output thereof becomes “1” when they match. The logical product circuit 905 outputs as a read state RS a logical product value of the output of the logical sum circuit 906 and the output of the comparator 904. When the read state RS is “1”, it indicates that the output node bit from the node map section 902 is valid.

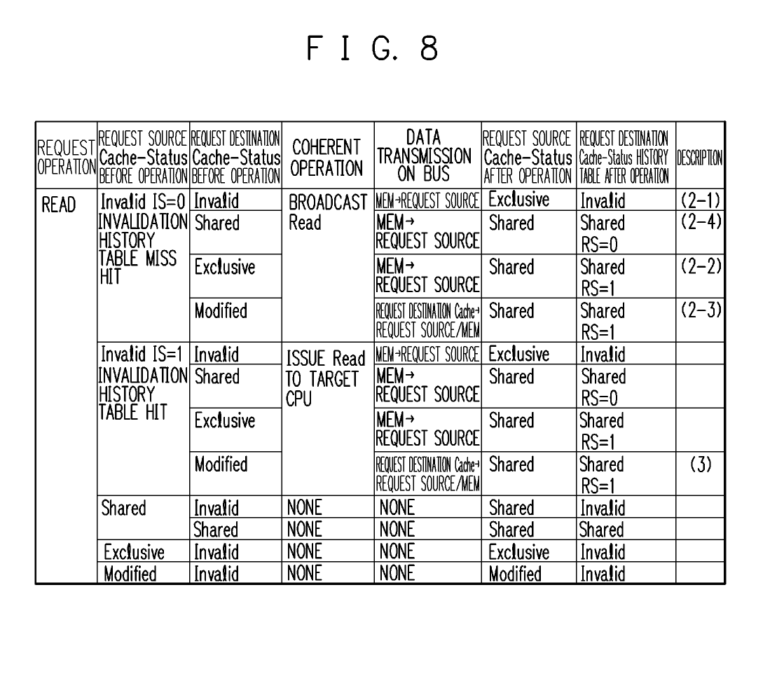

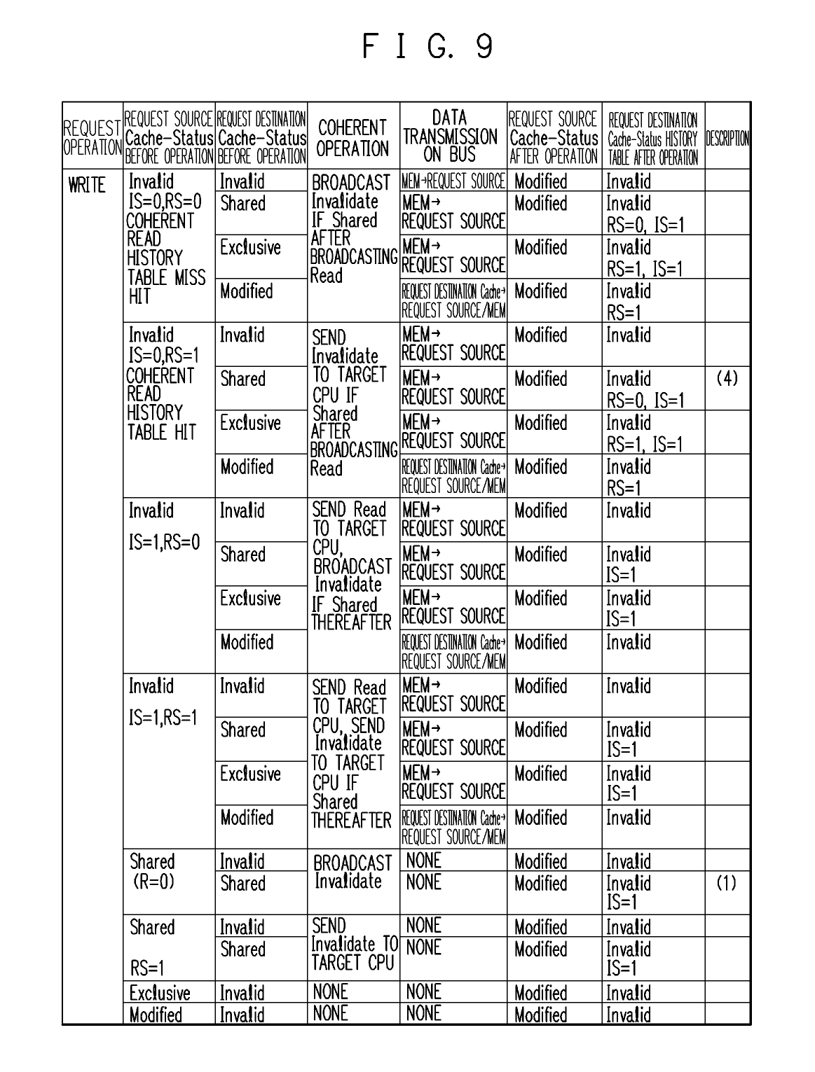

FIG. 8 and FIG. 9 illustrate flows of snooping and data when a read/write operation is performed from the statuses of the cache memories and states of the invalidation history table IHT and the coherent read history table RHT before operation, and also represent states after operation. Hereinafter, important parts in this embodiment will be described with reference to FIG. 1 to FIG. 5. Note that the descriptions of numbers in parentheses below correspond to numbers illustrated in “DESCRIPTION” in FIG. 8 and FIG. 9.

(1) when the Invalidate Request is Received from Another Node

In the case where a write instruction is carried out by the CPU 11, the status of the cache memory 31 is Shared in the first node 1, and the RHT=“0”, invalid, in the history table 41, the first node 1 broadcasts the invalidation request to the respective nodes. If the cache memory 32 in the second node 2 shares data and Status=Shared, the Status in the cache memory 32 is invalidated, and invalidation history information containing the upper address ADD2 in the tag section 401, a value “1” in the invalid bit 402, and a node number “1” in the node number 403 is registered on the line selected by a lower address ADD1 in the invalidation history table IHT in the history table 42. Further, in the case of this example, the invalidation request to the other nodes 3 to 6 results in a miss hit, and thus writing to the invalidation history tables in the history tables 43 to 46 is not performed. Then, the cache controller 21 rewrites data of the cache memory 31, and the Status in the cache memory 31 is changed to Modified.

(2) When the Coherent Read Request is Received from Another Node

When the first CPU 11 makes a read request of data at a certain address, if data at this address do not exist in the first cache memory 31, which is a miss hit, and also Invalid IS=0 in the invalidation history table in the history table 41, the coherent read request is issued to the respective nodes.

(2-1) Any one which does not hit among the cache memories 32 to 36 in the respective nodes which received the coherent read request, which is a miss hit, does not access the coherent read history table.

(2-2) When any one of the cache memories 32 to 36 which received the coherent read request hits, for example, the cache memory 32 hits in Status=Exclusive, the Status of the cache memory 32 is changed to Shared, and the following information is written at the lower address ADD1 to the coherent read history table in the history table 42. [1] The upper address ADD2 is written to the tag section 501, [2] “1” is written to the read bit section 502, and [3] the number of the node which issued the coherent read request is written to the node number section 503. Next, the occurrence of the hit is reported to the requesting node, and read data are read from the main memory 51 and sent to the requesting node. The Status of the cache memory in the request side node becomes Shared.

(2-3) When any one of the cache memories 32 to 36 which received the coherent read request hits, for example, the cache memory 32 hits in Status=Modified, the Status of the cache memory 32 is changed to Shared, and the following information is written at the lower address ADD1 to the coherent read history table in the history table 42. [1] The upper address ADD2 is written to the tag section 501, [2] “1” is written to the read bit section 502, and [3] the number of the node which issued the coherent read request is written to the node number section 503. Next, the occurrence of the hit is reported to the requesting node, and data read from the cache memory 32 is written back to the main memory 51 and is sent to the request source node. The Status of the cache memory in the request source node becomes Shared.

(2-4) When any one of the cache memories 32 to 36 which received the coherent read request hits, and for example the cache memories 32 and 33 share data, both the cache memories hit in Status=Shared. In this case, “0” is written to the read hit section 502 to change it to invalid at the lower address ADD1 in the coherent read history tables in both the history tables 42. In FIG. 5, only one node number can be stored in the coherent read history table 503 in the history table, that is, when the coherent read history table is valid, the coherent read request is issued from the node that is the request source only to one other node. Thus, when data are shared by three or more nodes and the invalidation request is issued to the other nodes by any one of the nodes which share the data, it is necessary to issue a request to two nodes. However, there is no such function in FIG. 5, and thus it needs to be broadcasted, that is, issued to all the nodes. Thus, write is performed so as to invalidate the coherent read history table. Of course, when the coherent read history table is expanded to allow storing two node numbers, the effect of this embodiment can be exhibited even when data are shared by three nodes. Moreover, one expansion of this is an embodiment of FIG. 10. In an example of FIG. 10, in order to store all the nodes which issued the coherent read request, the node map section 902 is provided in the coherent read history table RHT, in which respective bits correspond to the nodes one by one, and which nodes requests came from can all be stored even when the coherent read request is received from two or more nodes. Next, the occurrence of the hit is reported to the requesting node, and read data are read from the main memory 51 and sent to the requesting node. The Status of the cache memory in the request side node becomes Shared.

(3) When a Node Issues the Coherent Read Request

When the CPU 11 in the node 1 reads the cache memory 31, if necessary data are not present in the cache memory 31, that is, the Status in the cache memory is invalid or a miss hit, the cache controller 21 reads the invalidation history table IHT in the history table at the same address it accessed the cache memory 31. The invalidation history table IHT outputs the tag section 401 indicating the upper address corresponding to the lower address ADD1, the invalid bit 402, and the node number 403. When the invalidation history information is not registered in the invalidation history table IHT, the invalid bit 402 has a value “1”. As the node number 403, for example, the number of the second node 2 is outputted as a node number IN. The comparator 404 compares the tag section 401 outputted by the invalidation history table IHT and the upper address ADD2, and outputs “1” when the both match, or outputs “0” when the both do not match. The logical product circuit 405 outputs as an invalid state IS a logical product value of the output value of the comparator 404 and the invalid bit 402 outputted by the invalidation history table IHT.

When the invalidation history information of the address is registered in the invalidation history table IHT, the invalid state IS becomes “1”, and it is determined that the registered node number IN is valid. On the other hand, when the invalidation history information is not registered in the invalidation history table IHT, the invalid state IS becomes “0”.

When the output of the history table, the invalid state IS is “1”, the cache controller 21 turns on only the switch SW12 so as to output a coherent read request containing the address only to the node of the number indicated by the node number IN, for example the number 2 node if the number is “2”, executing a coherent read. Thus, all the switch paths are not occupied only by this coherent read, and the performance of the processing system can be improved. Further, a coherent read from the cache memory in a node which does not have necessary data no longer occurs, and thus causes for delay of access of CPU can be decreased.

The reason why it is necessary to issue the coherent read request only to the node 2 will be described. When data are shared by the nodes 1 and 2, if the node 2 attempts to rewrite the data, it issues the invalidation request to the other nodes 1, 3 to 6. This invalidation request hits in the node 1, and thus as described in (1), the relevant cache line is invalidated, and the invalidation address and the node number of this information are written in the invalidation history table. Thereafter, if there is an attempt to read the cache line in the node 1, a cache miss occurs because it is already invalidated. However, when the invalidation history table is read, it can be seen that the node that invalidated this cache line is the number 1 node. That is, it can be seen that it is highly possible that the node 1 which shared data in the past has the currently needed data. Therefore, it can be seen that it is just necessary to issue the coherent read request only to the number 1 node. If the data are not present in the node 1, the coherent read request is issued to all the other nodes.

When the invalid state IS of the output of the history table is “0”, the cache controller 21 outputs the coherent read request containing the address to all the other nodes 2 to 6.

(4) When the Node Issues the Invalidation Request

For example, when the node 1 and the node 2 share data at a certain address and the CPU 11 in the node 1 attempts to execute a write of data to this address, the CPU reads the cache memory 31 which is Shared and hits. In this case, the cache controller 21 reads the coherent read history table in the history table 41 at the same address as the access to the cache memory. When a read bit 502 as the output of the coherent read history table is “1”, valid, a hit occurs if data of the tag section 501 and the inputted upper address ADD2 match (RS=“1”), indicating that data RN of the node number section 503 are valid. When RS=“1”, valid, the cache controller 21 turns on only the switch SW12 so as to issue the invalidation request only to the node of the number=2 indicated by the data RN, and issues the invalidation request. Thus, all the switch paths are not occupied only by this invalidation request, and the performance of the processing system can be improved. In the node 2 which received the invalidation request, the relevant cache line is invalidated, and information of this is written to the invalidation history table. Further, access for invalidation to the cache memory in a node which does not share the data does not occur, and thus causes for delay of access of CPU can be decreased. After the invalidation is performed, data in the cache memory 31 in the node 1 are rewritten, and the Status is changed to Modified.

The reason why it is necessary to issue the invalidation request only to the node 2 will be described. As an assumption of this example, it was described that the node 1 and the node 2 share data. However, before the data are shared, first, for example, the cache memory 31 in the node 1 has already read data at a certain address from the main memory 51, and thereafter, when data at the same address become necessary in the node 2, the node 2 takes in the data by the coherent read request. At that time, in response to this coherent read, the node 1 sets the Status of the cache memory 31 to Shared, and writes information of the relevant address and the node number “2” to the coherent read history table in the history table 41 as described in (2). That is, the node 1 knows that the data of the address are shared with which node 2. Thus, when the node 1 issues the invalidation request to the address, it can be seen that it is necessary to issue the request only to the node 2.

Describing an example of the coherent read history table using FIG. 10, for example, the nodes 1, 2, 3 share data at a certain address, and when the CPU 11 in the node 1 attempts to execute writing of data at this address, the CPU reads the cache memory 31 which is Shared and hits. In this case, the cache controller 21 reads the coherent read history table in the history table 41 at the same address as the access to the cache memory. If data of the tag section 501 which is an output of the coherent read history table and the inputted upper address ADD2 match and any one of the node bit section is “1”, a hit occurs (RS=1), indicating that data RN of the node bit section 502 are valid. When RS=“1”, valid, the cache controller 21 turns on only the switches SW12 and SW13 so as to issue the invalidation request only to the nodes of bits indicated by the data RN=2 and 3, and issues the invalidation request.

The cache controller 21 issues the coherent read request to all the nodes when the output RS of the history table 41=“0”.

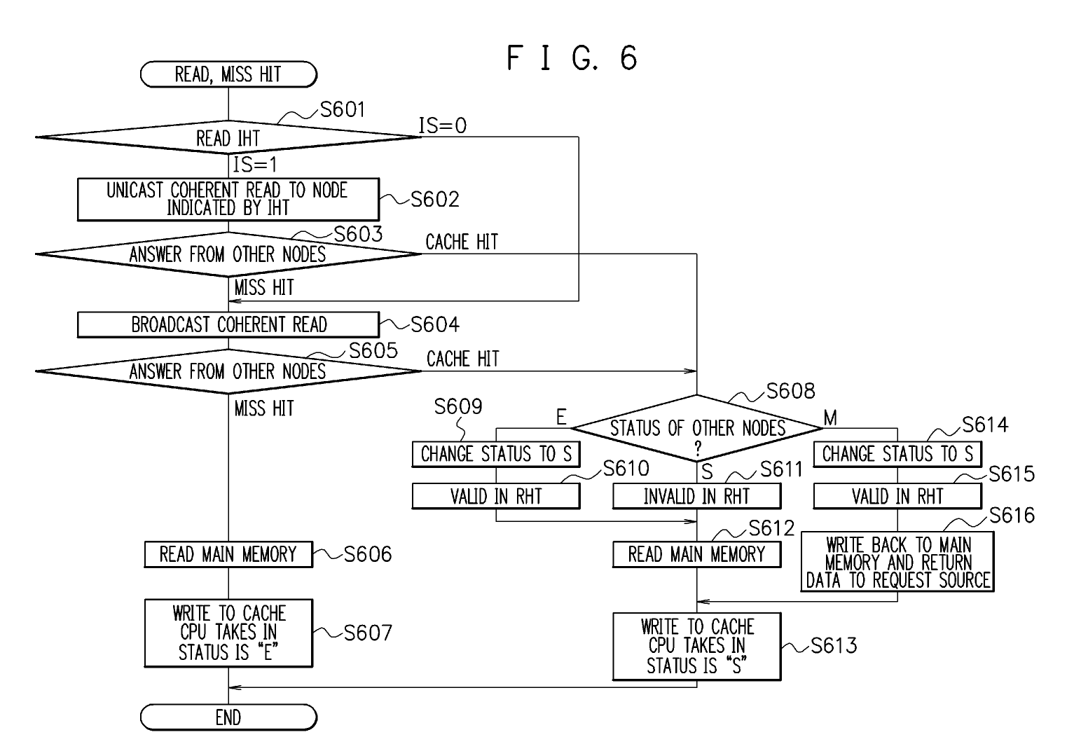

FIG. 6 is a flowchart illustrating processing when a CPU reads a cache and a miss hit occurs. When a cache hit occurs, the CPU reads the contents of the cache memory, and the processing finishes. Processing of the second node 2 at a time of a cache miss hit will be described for example, but the other nodes 1, 3 to 6 perform processing similarly to the second node 2. When the second CPU 12 issues a read request for data at a certain address, if the data at the address do not exist in the second cache memory 32 and a miss hit occurs, the processing of FIG. 6 is performed.

In step S601, the second cache controller 22 reads its own invalidation history table IHT by using the lower address ADD1 in the address of the read request as an input address. Further, the upper address ADD2 becomes an input of one side of its own comparator 404. The invalidation history table IHT outputs the tag section 401, the invalid bit 402, and the node number 403 by using the lower address ADD1 as the input address. When invalidation history information of the address is registered in the invalidation history table IHT, the invalid state IS becomes “1”, and the registered node number IN becomes valid. The flow proceeds to step S602. On the other hand, when the invalidation history information of this address is not registered in the invalidation history table IHT, the invalid state IS becomes “0”, and the flow proceeds to step S604.

In step S602, the second cache controller 22 outputs the coherent read request by unicast only to, for example, the first node 1 indicated by the node number IN.

Next, in step S603, when a miss hit occurs in the cache memory in the node 1 which received the coherent read request, the cache controller 22 in the node 2 has determined that the needed data exist in the node 1, but the data do not exist therein. Such an event occurs when data at another address become necessary since the capacity of the cache memory 31 is small, and hence they are rewritten. In this case, the flow proceeds to step S604. Further, when the answer from the node 1 is a cache hit, the cache controller 22 proceeds to step S608.

In step S604, the cache controller 22 outputs the coherent read request by broadcast to all the other nodes 1, 3 to 6. Note that when above-described step S602 is passed, for the node to which the coherent read request is already outputted in step S602, the coherent read request need not be outputted again.

Next, in step S605, when a cache miss hit occurs in all the other nodes 1, 3 to 6 with respect to the coherent read request issued by the cache controller 22, the flow proceeds to step S606. When a cache hit occurs in at least one of the other nodes 1, 3 to 6, the flow proceeds to step S608.

In step S606, seeing that the data needed by the node 2 do not exist in the other nodes, the cache controller 22 of the request source reads the data at this address from the main memory 51 via the main memory controller 52.

Next, in step S607, the cache controller 22 of the request source writes the data read from the main memory to the cache memory 32 corresponding to this address, and the CPU 12 takes in the data. The status of the cache memory 32 is changed to the exclusive state E. Thus, the read processing finishes.

Step S608 and later steps target only at a node in which a cache hit has occurred with respect to the coherent read request from the node 2. Any node which does not have a hit finishes.

In step S608, each of the cache controllers 21, 23 to 26 proceeds to step S609 when its status 302 is the exclusive state E, proceeds to step S611 when its status 302 is the shared state S, or proceeds to step S614 when its status 302 is the modified state M.

In step S609, the cache controller 21, 23 to 26 of the node 1, 3 to 6 changes to the shared state S the status 302 of the cache line corresponding to the address for which the coherent read request is issued in the cache memory 31, 33 to 36.

Next, in step S610, the cache controller 21, 23 to 26 of the node 1, 3 to 6 registers the upper address (tag) 501, the read bit 502 having a value “1”, and the node number 503 of the node 2 that is the request source in the coherent read history table RHT by using as an input address the lower address ADD1 of the address of the node 2 which issued the coherent read request. Thereafter, the flow proceeds to step S612.

In step S611, the cache controller 21, 23 to 26 of the node 1, 3 to 6 changes the read bit 502 to “0” to invalidate it in the coherent read history table RHT by using as an input address the lower address ADD1 of the address of the node 2 which issued the coherent read request. Thereafter, the flow proceeds to step S612.

In step S612, the cache controller 22 of the request source determines that the latest data desired to be read are in the main memory, and reads data of a necessary address from the main memory 51. Thereafter, the flow proceeds to step S613.

In step S614, the cache controller 21, 23 to 26 of the node 1, 3 to 6 changes the status 302 of the cache line corresponding to the address for which the coherent read request is issued in the cache memories 31, 33 to 36 to the shared state S.

Next, in step S615, the cache controller 21, 23 to 26 of the node 1, 3 to 6 registers the upper address (tag) 501, the read bit 502 having a value “1”, and the node number 503 of the node 2 that is the request source in the coherent read history table RHT by using as an input address the lower address ADD1 of the address of the node 2 which issued the coherent read request.

Next, in step S616, the status of the cache memory which is read coherently is M, which means, specifically, the latest data exist in one of the cache memories 31, 33 to 36, and thus the cache controller 21, 23 to 26 of the node 1, 3 to 6 in which the data exist writes back the data read from the cache memories 31, 33 to 36 to the main memory 51. Accompanying this, these data are returned to the node 2 that is the request source. Thereafter, the flow proceeds to step S613.

In step S613, the cache controller 22 of the request source writes the obtained latest data to the cache memory 32. At the same time, the CPU 12 takes in these data. The status 302 of the relevant cache line then changes to the shared state S. Thus, the read processing finishes.

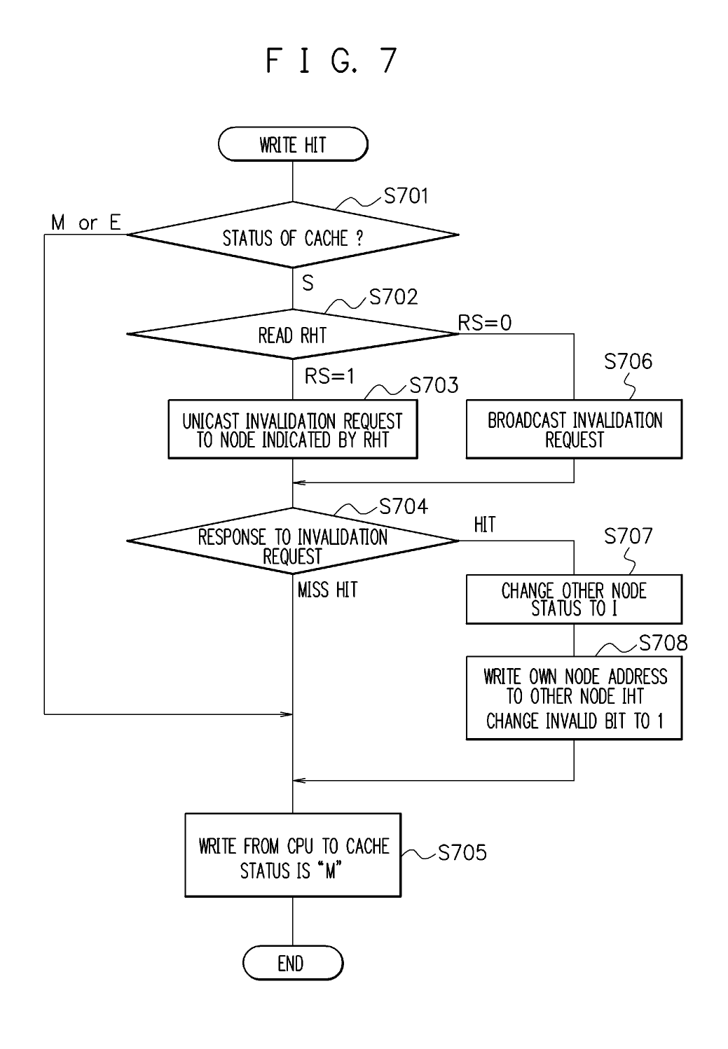

FIG. 7 is a flowchart illustrating write processing of the first node 1. Note that this flowchart is only for the case where a cache hit occurs to an address at which a CPU attempts to write. Processing of the node 1 will be described as an example below, but the other nodes 2 to 6 perform the same processing as the first node 1. When the first CPU 11 issues a write request of data at a certain address in its own cache memory 31, the processing of FIG. 7 is performed.

In step S701, the cache controller 21 proceeds to step S705 when the address in its cache memory 31 at which it attempts to write hits a cache line and the corresponding status 302 is the modified state M or the exclusive state E, or proceeds to step S702 when it is the shared state S. Note that when the status 302 is in the invalid state I or a miss hit occurs, the processing of read miss illustrated in FIG. 6 is performed, and thereafter processing of FIG. 7 is performed.

In step S702, the cache controller 21 reads the coherent read history table RHT by using the lower address ADD1 in the address of the aforementioned write request as an address input, and if the read bit 502 is “1”, valid, and comparison of the upper address ADD2 and the tag section 501 by the comparator 504 result in a match, RS becomes 1, indicating that an output RN of the node number 503 is valid. That is, when the coherent read history information is registered in the coherent read history table RHT, the read state RS becomes “1”, the registered node number RN becomes valid, and the flow proceeds to step S703. In this respect, when the coherent read history information of this address is not registered in the coherent read history table RHT, the read state RS becomes “0”, and the flow proceeds to step S706.

In step S703, the cache controller 21 outputs the invalidation request by unicast only to, for example, the second node 2 indicated by the node number RN. Thereafter, the flow proceeds to step S704.

In step S706, the cache controller 21 outputs the invalidation request by broadcast to all the other nodes 2 to 6. Thereafter, it proceeds to step S704.

In step S704, a node in which a cache hit did not occur to the cache controller 21 which issued the invalidation request does nothing, and proceeds to step S705. A node in which a hit occurred, for example the second cache controller 22, proceeds to step S707.

In step S707, the cache controller 22 to 26 of the node 2 to 6 changes to the invalid state I the status 302 corresponding to the cache line, for which the invalidation request was issued, in its own cache memory 32 to 36.

Next, in step S708, the cache controller 22 to 26 of the node 2 to 6 registers in the node number section 403 in its own invalidation history table IHT the upper address (tag) 401, the invalid bit 402 having a value “1”, and the first node 1 that is the request source by using the lower address ADD1 of the address of the aforementioned invalidation request as an address input. Thereafter, it proceeds to step S705.

In step S705, according to the aforementioned write request, the first CPU 11 of the request source writes data thereof to the data section 303 in its own cache memory 31, and changes the status 302 to the modified state M. Thus, the write processing finishes.

Note that although the mutual coupling network using the switches SW12 to SW67 is described as an example in FIG. 1, any other mutual coupling network such as a ring bus or a common bus may be employed. Further, the structure of the cache memory in this embodiment employs the direct map method, but when a set associative method is employed, adaptation to this method is possible by preparing a history table corresponding to the number of ways thereof. Further, writing is of a write back method, but a write through method may be employed without any problem. Further, the status 302 of FIG. 3 in this embodiment has been described with an example of what is called a MESI type which indicates one of the invalid state I, the shared state S, the exclusive state E, and the modified state M, but any other method such as MOESI may also be employed.

In this embodiment, in the processing system in which plural CPUs perform information processing in association with each other, by identifying a CPU that should receive a snoop request, occurrence of unconditional output of a snoop request by plural CPUs to all the other CPUs decreases, and data congestion on the mutual coupling network decreases, thereby apparently improving performance of the mutual coupling network. Further, receiving a reduced number of snoop requests, cache memories can concentrate on requests from the CPU which are their original purposes, and this contributes to processing performance improvement.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

By outputting the coherent read request only to another processing device registered in the invalidation history table or outputting the invalidation request only to another processing device registered in the coherent read history table, unconditional output of the coherent read request or invalidation request by plural processing devices to all other processing devices decreases, and data congestion on the mutual coupling network decreases, thereby improving performance. Further, receiving a reduced number of coherent read requests or invalidation requests, cache memories can concentrate on read/write requests from the central processing unit which are their original purposes, and this contributes to processing performance improvement.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processing device, comprising:
a cache memory which stores a copy of part of data of a main memory;
a central processing unit which accesses data in the cache memory;
a cache controller which controls the cache memory; and
an invalidation history table, wherein:
when an invalidation request is inputted from another processing device, the cache controller registers a set of an invalidation request address which the invalidation request has and an identifier of the other processing device which outputted the invalidation request in the invalidation history table; and
when the central processing unit attempts to read data at a first address not stored in the cache memory, if the first address is registered in the invalidation history table, the cache controller outputs a coherent read request containing the first address to the other processing device indicated by the identifier of the other processing device which outputted the invalidation request corresponding to the first address, or if the first address is not registered in the invalidation history table, the cache controller outputs a coherent read request containing the first address to all other processing devices.

2. The processing device according to claim 1, wherein
when an indication that data at the first address from the other processing device are in an invalid state is inputted as a result of outputting the coherent read request containing the first address to the other processing device indicated by the identifier of the other processing device which outputted the invalidation request corresponding to the first address registered in the invalidation history table, the cache controller outputs a coherent read request containing the first address to all the other processing devices.

3. A processing device, comprising:
a cache memory which stores a copy of part of data of a main memory;
a central processing unit which accesses data in the cache memory;
a cache controller which controls the cache memory; and
a coherent read history table, wherein:
when a coherent read request is inputted from another processing device, the cache controller registers a set of a coherent read request address which the coherent read request has and an identifier of the other processing device which outputted the coherent read request in the coherent read history table; and
when the central processing unit attempts to rewrite data at a second address of the cache memory, if the second address is registered in the coherent read history table, the cache controller outputs an invalidation request containing the second address to the other processing device indicated by the identifier of the other processing device which corresponds to the second address registered in the coherent read history table, or if the second address is not registered in the coherent read history table, the cache controller outputs an invalidation request containing the second address to all other processing devices.

4. The processing device according to claim 3, wherein
when the set of the coherent read request address and the identifier of the other processing device is already registered in the coherent read history table and there is a registration request to the coherent read history table at a same address from another processing device, data registration at the same address in the coherent read history table is invalidated.

5. A processing device, comprising:
a cache memory which stores a copy of part of data of a main memory;
a central processing unit which accesses data in the cache memory;
a cache controller which controls the cache memory; and
a coherent read history table, wherein:
when a coherent read request is inputted from another processing device, the cache controller changes bits corresponding to a coherent read request address which the coherent read request has and the other processing device which outputted the coherent read request to indicated that there is a coherent read request in the coherent read history table; and
when the central processing unit inputs a request to rewrite data at a third address of the cache memory, if the third address is registered in the coherent read history table, the cache controller outputs an invalidation request containing the third address to another processing device corresponding to a bit position indicating that there is a coherent read request in the coherent read history table, or if the third address is not registered in the coherent read history table, the cache controller outputs an invalidation request containing the third address to all other processing devices.
